(19) United States
(12) Patent Application Publication
(10) Pub. No.: US 2009/0114680 A1
(43) Pub. Date: May 7, 2009

(54) Beverage dispense

(75) Inventors: Graham Frederick Williams, Solihull (GB); Rodney John Adams, London (GB); Gary Underwood, Bicester (GB)

Correspondence Address: PYLE & PIONTEK LLC, 221 N. LASALLE STREET, SUITE 1207, CHICAGO, IL, 60601, US

(73) Assignee: IMI Cornelius Inc.

(21) Appl. No.: 12/008,307

(22) Filed: Jan. 10, 2008

(30) Foreign Application Priority Data
Nov. 1, 2007 (GB) 0700520.0

(51) Int. Cl. B67D 5/06

(52) U.S. Cl. 222/144.5

(57) ABSTRACT

This invention discloses dispensing post-mix beverages, and a manually operable valve assembly for mixing a concentrate such as a syrup or flavor with a diluent to form a post-mix beverage, such as a hand-held multi-product beverage dispense valve assembly for bar guns. The present invention reduces cross-contamination of dispensed beverages, completes draining of the beverage at the end of the dispense in a short time, and improves hygiene.

This application is a non-provisional United States patent application and claims priority and the filing date of United Kingdom application No. 0700520.0 filed Jan. 11, 2007 and incorporates the same by reference.

This invention relates to an apparatus and method for dispensing post-mix beverages. More especially the invention is concerned with a manually operable valve assembly for mixing a concentrate such as a syrup or flavor with a diluent such as still or carbonated water to form a post-mix beverage such as colas, fruit juices, etc. The invention has particular application to a hand-held multi-product beverage dispense valve assembly for dispensing any selected one of a plurality of post-mix beverages.

### BACKGROUND OF THE INVENTION

In hand-held multi-product beverage dispense valve assemblies, also commonly known as bar guns, supplies of diluent and concentrate are fed to individual valves in a dispense head that can be held in the hand and has a plurality of buttons or the like for manual selection and operation to dispense diluent separately or in combination with a flavor. Typically, when dispensing such post-mix beverages, a large volume of diluent is mixed with a small volume of concentrate, for example a diluent to concentrate ratio of 6:1, to produce the desired post-mix beverage.

A commonly occurring problem in the known bar guns, is cross-contamination of beverages due to carry-over of concentrate after a beverage has been dispensed into subsequently dispensed beverages. This can arise in a number of ways. For example, concentrate flowing into the dispense nozzle may adhere to internal surfaces of the nozzle where it remains and is washed into subsequently dispensed beverages. Due to the high concentration of the concentrates used to produce the beverages, such contamination can have an adverse effect on the appearance of the beverage, particularly where the contaminating concentrate is highly colored, with the result that the beverage is rejected by the customer, even if the taste of the beverage is not affected. Carry-over of the concentrate may also occur where the valve controlling flow of concentrate discharges into a duct opening to the nozzle resulting in a volume of concentrate remaining in the duct downstream of the valve at the end of dispense that can be sucked out of the duct by the vacuum created by the flow of diluent when the next beverage is dispensed.

Another problem often encountered with the known bar guns is slow or incomplete draining at the end of the dispense that can also lead to cross-contamination of subsequently dispensed beverages by any undispensed beverage remaining in the gun at the end of the dispense.

Yet another problem found in many known bar guns is poor or incomplete mixing of the diluent and concentrate before the beverage is dispensed into a glass or other receptacle that can lead to stratification (different layers) of the beverage in the glass which can affect the appearance and taste of the beverage.

A further problem occurring in many known bar guns that dispense carbonated beverages is poor retention of carbonation levels in the dispensed beverage due to uncontrolled break-out of carbon dioxide during dispense, particularly within the gun.

Other problems commonly associated with known bar guns include poor hygiene due to the presence of areas within the gun, especially small holes and ports where deposits of beverage components especially the more viscous concentrates can build up and/or where insects can become trapped leading to blockages that affect the dispense.

### SUMMARY OF THE INVENTION

The present invention has been made from a consideration of the foregoing and seeks to provide an apparatus and method for dispensing post-mix beverages that mitigates one or more of the foregoing problems and disadvantages of known bar guns.

More especially, it is a desired aim of the present invention to provide an apparatus and method for dispensing post-mix beverages in which the occurrence of cross-contamination of dispensed beverages is reduced.

It is a further desired aim of the present invention to provide an apparatus and method for dispensing post-mix beverages in which mixing of diluent and concentrate is enhanced before dispense of the beverage into a receptacle and/or in which substantially complete draining of the beverage into the receptacle occurs at the end the dispense in a short time.

It is yet another desired aim of the present invention to provide an apparatus and method for dispensing post-mix beverages in which hygiene levels are improved.

These and other preferred aims of the present invention will be more fully understood from the description hereinafter.

According to one aspect of the invention, there is provided apparatus for dispensing a post-mix beverage comprising a valve assembly for dispensing a diluent and a concentrate wherein dispense of the diluent starts before and finishes after dispense of the concentrate.

By this aspect of the invention, the concentrate is always added to a volume of diluent. Also, the presence of a volume of diluent reduces the risk of concentrate adhering to internal surfaces.

In at least one embodiment, the valve assembly may dispense the diluent with any selected one of a plurality of concentrates for dispense of a range of different beverages.

In at least one embodiment, the valve assembly may dispense the diluent with or without addition of concentrate. For example, the diluent may be still or carbonated water that can be dispensed with or without a concentrate such as a syrup or flavor.

In at least one embodiment, the valve assembly may dispense the concentrate into a stream of diluent that flows over a port through which the concentrate flows. In this way, the diluent picks up the concentrate when the port is open during dispense and the port is flushed with diluent at the end of the dispense when the port is closed.

According to another aspect of the invention, there is provided a method of dispensing a post-mix beverage comprising a valve assembly for dispensing a diluent, dispensing a concentrate and mixing the diluent and concentrate wherein dispense of the diluent starts before and finishes after dispense of the concentrate.

According to a further aspect of the invention, there is provided apparatus for dispensing a post-mix beverage comprising a valve assembly including a diluent valve for controlling flow of a diluent and a concentrate valve for controlling flow of a concentrate, and a chamber in which diluent from the diluent valve and concentrate from the concentrate valve are mixed, wherein the concentrate valve has an outlet through which concentrate can flow directly into the chamber when the outlet is open and which prevents flow of concentrate when the outlet is closed.

By this aspect of the invention, when the outlet of the concentrate valve is open, all the concentrate flowing through the outlet enters the mixing chamber for mixing with diluent and, when the concentrate valve is closed, no volume of concentrate downstream of the concentrate valve is present.

In at least one embodiment, the diluent dispense valve opens before and closes after the concentrate dispense valve. In this way, the concentrate is always added to a volume of diluent in the mixing chamber.

In at least one embodiment, the concentrate may flow through the outlet of the concentrate valve into a stream of diluent that flows over the outlet. In this way, the diluent picks up the concentrate when the outlet is open during dispense and the outlet is flushed with diluent at the end of the dispense when the outlet is closed.

In at least one embodiment, the valve assembly may include a plurality of concentrate valves and diluent from the diluent valve may be mixed with concentrate from any selected one of the concentrate valves.

According to another aspect of the invention, there is provided a method of dispensing a post-mix beverage comprising mixing a diluent and a concentrate in a chamber to produce a beverage wherein flow of concentrate to the chamber is controlled with a valve configured to admit concentrate directly to the chamber.

According to another aspect of the invention, there is provided a valve assembly including a diluent valve for controlling flow of a diluent and a concentrate valve for controlling flow of a concentrate, and a chamber in which diluent from the diluent valve and concentrate from the concentrate valve are mixed, wherein a flow deflector is provided in the chamber for promoting mixing of the diluent and concentrate.

By this aspect of the invention, mixing of the diluent and concentrate is improved by use of a flow deflector in the chamber. The flow deflector may also help to reduce break-out where the diluent contains a dissolved gas such as carbon dioxide so as to maintain carbonation levels in the dispensed beverage.

In at least one embodiment, the flow deflector is arranged to direct at least some of the diluent flow from the diluent valve to flow across an outlet from the concentrate valve so that concentrate from the concentrate valve flows into the diluent flowing across the outlet. In this way, the diluent picks up the concentrate when the outlet is open during dispense.

In at least one embodiment, the diluent dispense valve opens before and closes after the concentrate dispense valve. In this way, the concentrate is always added to a volume of diluent in the mixing chamber and the outlet is flushed with diluent at the end of the dispense when the outlet is closed.

In at least one embodiment, the valve assembly may include a plurality of concentrate valves such that diluent from the diluent valve may be mixed with concentrate from any selected one of the concentrate valves and the deflector promotes mixing of the diluent with concentrate from any selected concentrate valve.

According to a further aspect of the invention, there is provided a method of dispensing a post-mix beverage comprising mixing a diluent and a concentrate in a chamber to produce a beverage wherein mixing of the diluent and concentrate is promoted by a flow deflector arranged in the chamber.

According to another aspect of the invention, there is provided apparatus for dispensing a post-mix beverage comprising a valve assembly including a diluent valve for controlling flow of a diluent and a concentrate valve for controlling flow of a concentrate, and a chamber in which diluent from the diluent valve and concentrate from the concentrate valve are mixed, the concentrate valve having an outlet through which concentrate can flow into the chamber, means provided in the chamber for directing diluent from the diluent valve towards the outlet, and actuator means for operating the diluent valve and concentrate valve, said actuator means being configured for dispensing a mixture of diluent and concentrate wherein the diluent valve doses after the concentrate valve.

According to a still further aspect of the invention, there is provided a method of dispensing a post-mix beverage comprising providing a valve for admitting diluent to a mixing chamber at a first position, providing a valve for admitting concentrate to a mixing chamber at a second position, opening the diluent and concentrate valves, directing diluent towards the second position, and closing the diluent valve after the concentrate valve.

In the foregoing aspects of the invention, the apparatus may be in the form of a bar gun in which supplies of diluent and concentrate are fed to the gun in separate lines contained in a flexible hose that permits the gun to be held and maneuvered while operating the gun to dispense a selected beverage into a receptacle such as a glass via a nozzle.

In at least one embodiment, the diluent and concentrate lines are connected to respective flow control valves and the gun is provided with an array of buttons for manual operation to dispense diluent or a mixture of diluent and concentrate. Where a mixture of diluent and concentrate is dispensed, the diluent flow control valve may be opened before and closed after the concentrate flow control valve.In this way, the concentrate flows into the diluent during dispense and, at the end of the dispense, the nozzle is flushed with diluent to remove traces of concentrate.

### BRIEF DESCRIPTION OF THE DRAWING

The invention will now be described in more detail by way of example only with reference to the accompanying drawings in which:

FIG. 1 is a perspective view of a bar gun embodying the invention;

FIG. 2 is a side view of the bar gun shown in FIG. 1;

FIG. 3 is a plan view of the bar gun shown in FIG. 1;

FIG. 4 is a front view of the bar gun shown in FIG. 1;

FIG. 5 is an exploded isometric view of the bar gun shown in FIGS. 1 to 4;

FIG. 6 is a plan view of the valve head assembly shown in FIG. 5;

FIG. 7 is a side view of the valve head assembly shown in FIG. 5;

FIG. 8 is a section on the line 8-8 of FIG. 6; and

FIG. 9 is an exploded isometric view of the valve head assembly shown in FIGS. 5 to 8.

### DESCRIPTION OF THE PREFERRED EMBODIMENTS

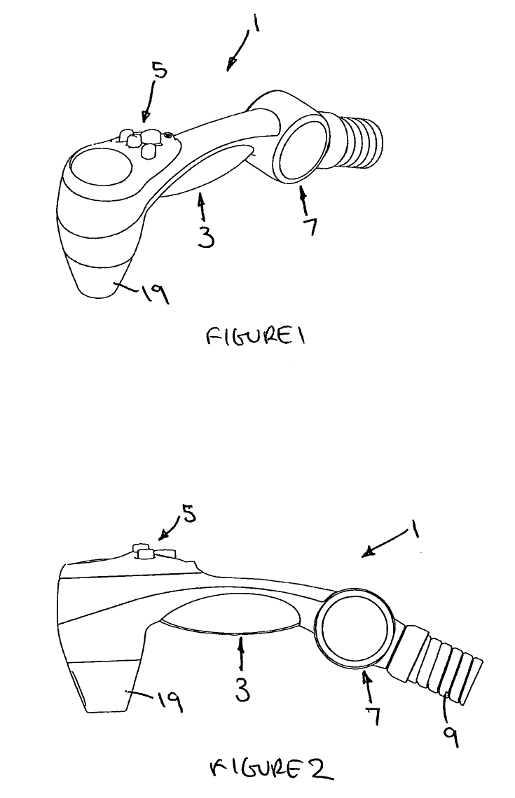

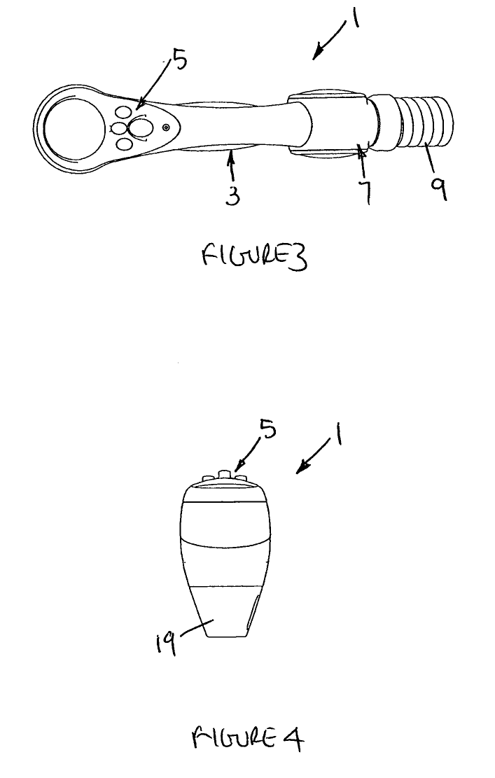

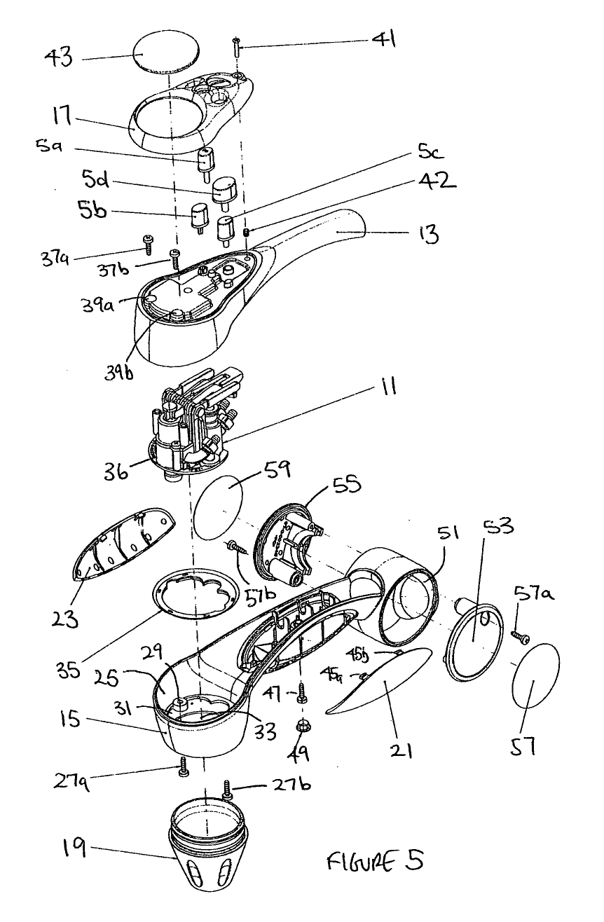

Referring first to FIGS. 1 to 5 of the accompanying drawings, there is shown apparatus for dispensing post-mix beverages in the form of a bar gun 1. The gun 1 comprises a handle 3 for the user to grip and hold the gun 1 with a plurality of buttons 5 provided on the upper surface of the handle 3 at one end of the gun 1 for user actuation to dispense a selected beverage. In this embodiment, four buttons are provided of which three buttons 5a, 5b, 5c control flow of concentrates such as syrups or flavors and a fourth button 5d controls flow of diluent such as still or carbonated water. As described in more detail later, depression of the diluent button 5d dispenses diluent only while depression of each concentrate button 5a, 5b, 5c dispenses a mixture of concentrate and diluent.

It will be understood that other combinations of buttons may be employed depending on the number and/or type of post-mix beverages the gun can dispense. For example, more than or less than three concentrate buttons may be employed. More than one diluent button may be provided. For example, two diluent buttons may be provided, one for still water and one for carbonated water. All possible combinations of buttons are envisaged and within the scope of the invention.

The other end of the handle 3 is provided with a boss 7 for connecting a flexible hose 9 containing four lines (not shown) connected to remote sources (not shown) of the concentrates and diluent. The lines pass through the handle 3 and are connected to a dispense valve assembly 11 housed within the handle 3 and operable by the buttons 5 to dispense the selected beverage as described in more detail later. The diluent and concentrate lines may pass through a remote cooler (not shown) before passing through the hose 9 to the gun 1 for dispense of chilled beverages. A coolant re-circulation loop may be provided in the hose 9 for circulating a cooling medium to prevent the diluent and concentrate warming up in the hose 9. Any suitable cooling medium may be employed.

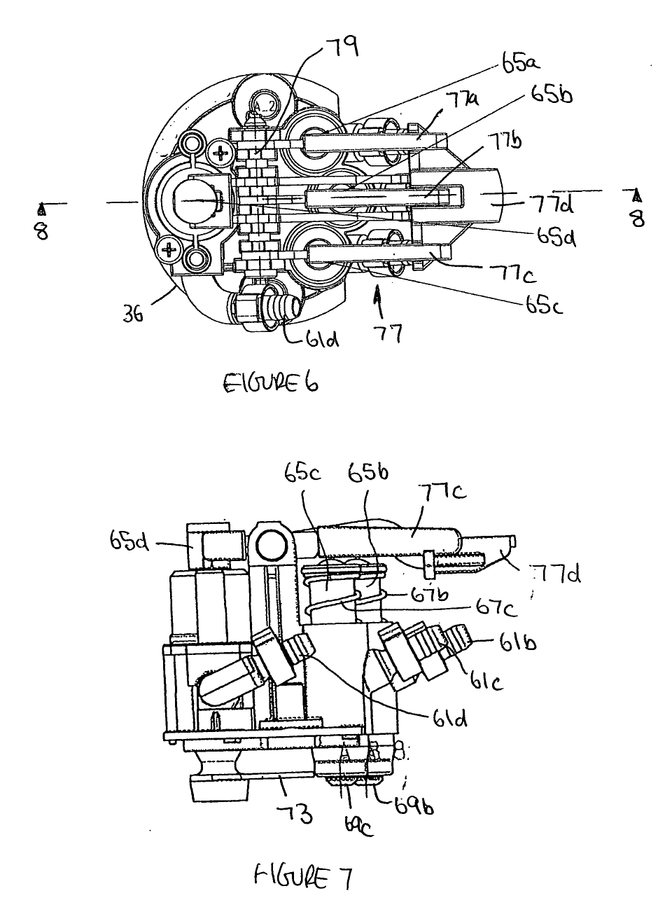

As best shown in FIG. 5, the body of the handle 3 comprises an assembly of a plurality of components, typically plastic moldings, including upper and lower main body parts 13, 15, a cover part 17, a nozzle 19 and side grips 21,23.

The valve assembly 11 is received in a cavity 25 in the lower body part and is secured to the lower body part 15 by a pair of screws 27a, 27b passed through holes 29 (one only shown) in a ledge 31 surrounding an opening 33.

The nozzle 19 is connected at the upper end to the opening 33 to receive liquid discharged by the valve assembly 11 and tapers inwardly to a central hole (not shown) at the lower end for beverage dispense into a receptacle such as a glass (not shown).

A gasket 35 interposed between the ledge 31 and a flange 36 of the valve assembly 11 provides a fluid tight seal to prevent leakage of liquid discharged by the valve assembly 11 into the interior of the handle 3.

The upper body part 13 locates on the lower body part 15 and closes the cavity 25 to conceal the valve assembly 11. The upper body part 13 is secured to the valve assembly 11 by a pair of screws 37a, 37b inserted through holes 39a, 39b in the upper body part 13, and the lower body part 15 is secured to the upper body part 13 by a screw 47 provided with a removable cover part 49.

The buttons 3 are mounted on the upper body part 13 and retained by the cover part 17 that is secured to the upper body part 13 by a screw 41 engaging a threaded insert 42 secured in the cover part 17. The cover part 17 is provided with a disc 43 carrying information to identify the beverage dispensed by each of the concentrate buttons 5a, 5b, 5c.

The side grips 21, 23 are similar and are located and retained on opposite sides of a central region of the lower body part 15 by tabs 45a, 45b.

The boss 7 has a transverse through bore 51 closed at the ends by a pair of caps 53,55 secured together by screws 57a, 57b and provided with discs 57, 59 carrying advertising, branding or other product information.

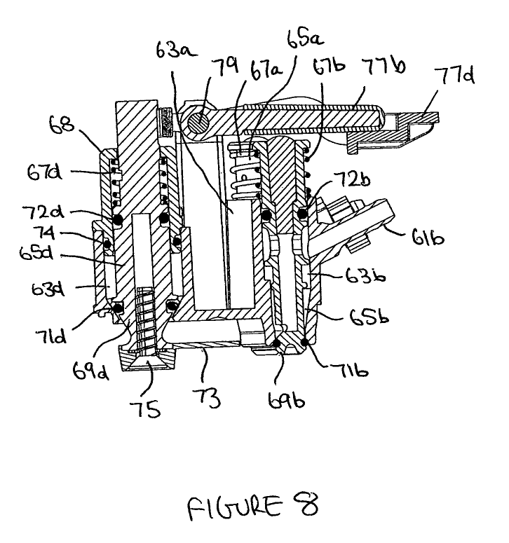

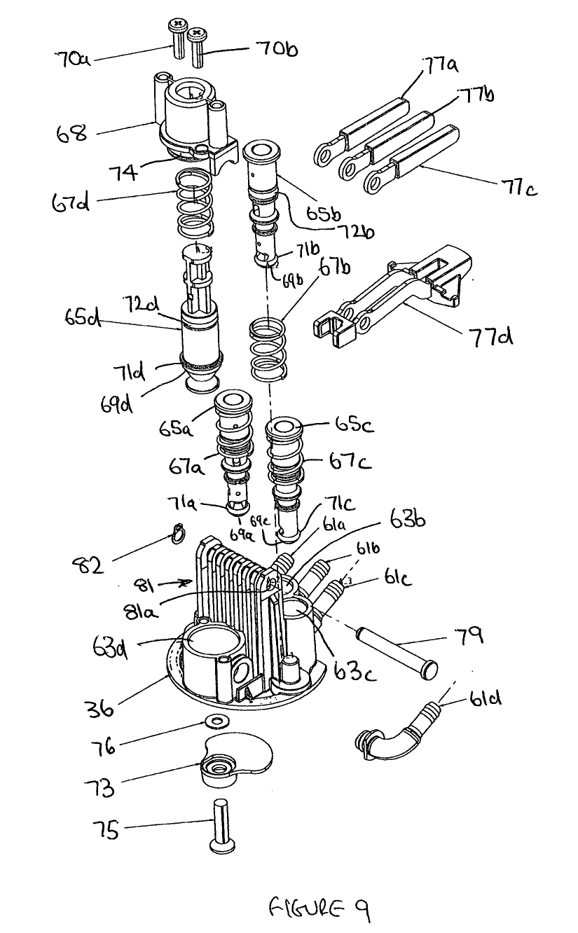

Referring now to FIGS. 6 to 9, the dispense valve assembly 11 is shown in more detail and includes nipples 61a, 61b, 61c for connecting each of the concentrate lines to a respective concentrate flow control valve and a nipple 61d for connecting the diluent line to a diluent flow control valve.

Each concentrate flow control valve includes a respective valve chamber 63a, 63b, 63c in which a concentrate valve piston 65a, 65b, 65c is slidably received for movement between open and dosed positions.

Each concentrate valve piston 65a, 65b, 65c is biased to the closed position in which the piston closes a port at the lower end of the associated concentrate valve chamber 63a, 63b, 6c by a separate spring 67a, 67b, 67c respectively acting between an upper end of the piston and the valve chamber.

Each piston 65a, 65b, 65c has a head 69a, 69b, 69c respectively carrying an O-ring 71a, 71b, 71c respectively that provides a fluid-tight seal with the associated port preventing leakage of concentrate in the dosed position.

Each piston 65a, 65b, 65c also carries an O-ring 72a, 72b, 72c respectively that provides a fluid-tight seal with the bore of the valve chamber 63a, 63b, 63c for sling movement of the piston 65a, 65b, 65c.

Each O-ring 72a, 72b, 72c is of larger diameter than the O-ring 71a, 71b, 71c whereby each piston 65a, 65b, 65c is also biased to the closed position by concentrate pressure in the valve chamber 63a, 63b, 63c. As a result, a fluid-tight seal that prevents leakage of concentrate in the closed position can be obtained using a weaker spring making it easier to operate the concentrate flow control valves.

The diluent flow control valve includes a valve chamber 63d in which a valve piston 65d is received for movement between open and closed positions.

The valve piston 65d is biased to the closed position in which the piston closes a port at the lower end of the diluent valve chamber 63d by a spring 67d acting between the piston 65d and a piston retainer 68 secured at the upper end of the valve chamber 63d by a pair of screws 70a, 70b and sealed by an O-ring 74.

The diluent piston 65d has a head 69d carrying an O-ring 71d that provides a fluid-tight seal with the port preventing leakage of diluent in the dosed position.

The diluent piston 65d also carries an O-ring 72d that provides a fluid-tight seal with the bore of the retainer 68 for sliding movement of the piston 65d between the open and closed positions.

The O-ring 72d is of smaller diameter than the O-ring 71d whereby the diluent piston 65d is also biased to the closed position by diluent pressure in the valve chamber 63d. As a result, a fluid-tight seal that prevents leakage of diluent in the closed position can be obtained using a weaker spring making it easier to operate the diluent flow control valve.

The head 69d of the diluent piston 65d projects through the port and a deflector plate 73 is secured to the head 69d by a screw 75. A washer 76 loosely connects the screw 75 to the deflector plate 73 for assembly/disassembly purposes. The head 69d and deflector plate 73 are configured so that, when the diluent piston 65d is in the open position, at least part of the diluent flow is directed towards the concentrate flow control valve ports. In a modification (not shown), the deflector plate 73 may be integral with the piston head 69d. In another modification (not shown), the deflector plate 73 is mounted on or integral with the nozzle 19.

The concentrate valve pistons 65a, 65b, 65c and diluent valve piston 65d are operable to control the flows of concentrate and diluent admitted to the nozzle 19 by a control lever assembly 77 in response to the actuation of the buttons 5a, 5b, 5c, 5d.

The lever assembly 77 includes a respective lever 77a, 77b, 77c for each concentrate piston 65a, 65b, 65c and a lever 77d for the diluent piston 65d.

Each concentrate lever 77a, 77b, 77c is pivotally mounted at one end on a pivot pin 79 that extends through aligned holes 81a in a mounting block 81 and is secured by a circlip 82. The other, actuator end of each concentrate lever 77a, 77b, 77c freely rests on and is supported at the actuator end of the diluent lever 77d.

The diluent lever 77d is pivotally mounted intermediate its ends on the pivot pin 79 and the end remote from the actuator end is coupled to the upper end of the diluent piston 65d.

The concentrate and diluent buttons 5a, 5b, 5c, 5d are aligned with the actuator ends of the corresponding concentrate and diluent levers 77a, 77b, 77c, 77d respectively and are operable to control flow of diluent only or a mixture of diluent and concentrate into the nozzle 19.

In use of the bar gun, when the diluent button 5d is depressed, the diluent lever 77d pivots about the pivot pin 79 and lifts the diluent piston 65d against the biasing of the return spring 67d and diluent pressure from the closed position to the open position in which the piston head 69d is moved to open the port and allow diluent to flow from the valve chamber 63d into the nozzle 19 for discharge into receptacle placed under the nozzle 19.

The actuator ends of the concentrate levers 77a, 77b, 77c rest on and are supported by the diluent lever 77d and can fall under gravity as the diluent lever 77d pivots in response to depression of the diluent button 5d until the concentrate levers 77a, 77b, 77c come into contact with the concentrate pistons 65a, 65b, 65c. However, no force is applied to the concentrate levers 77a, 77b, 77c and the concentrate pistons 65a, 65b, 65c remain in the closed position under the biasing of the associated return springs 67a, 67b, 67c and concentrate pressure so that only diluent flows into the nozzle 19 when the diluent button 5d is depressed. When one of the concentrate buttons 5a, 5b, 5c is depressed, the associated concentrate lever 77a, 77b, 77c pivots about the pin 79 and causes the diluent lever 77d to also pivot about the pin 79. The concentrate levers 77a, 77b, 77c are initially spaced above the top of the associated concentrate piston 65a, 65b, 65c. As a result, when any of the concentrate buttons 5a, 5b, 5c is depressed, the diluent lever 77d initially pivots to lift the diluent piston 65d and allow diluent to flow into the nozzle 19 before the concentrate lever 77a, 77b, 77c actuated by the selected button 5a, 5b, 5c contacts the associated concentrate piston 65a, 65b, 65c. Further depression of the selected button 5a, 5b, 5c causes the actuated concentrate lever 77a, 77b, 77c to lower the associated piston 65a, 65b, 65c against the biasing of the return spring 67a, 67b, 67c and concentrate pressure from the closed position to the open position in which the piston head 69a, 69b, 69c is moved to open the port and allow concentrate to flow from the valve chamber 63a, 63b, 63c into the nozzle 19 where it mixes with the diluent for discharge of the selected beverage into a receptacle placed under the nozzle 19.

When the concentrate button 5a, 5b, 5c for the selected beverage is released, the associated concentrate piston 65a, 65b, 65c returns to the closed position under the biasing of the associated return spring 67a, 67b, 67c and concentrate pressure to shut-off flow of concentrate into the nozzle 19 before the diluent piston 65d returns to the dosed position under the biasing of the return spring 67d and diluent pressure.

In this way, when a beverage is selected in which diluent is mixed with a concentrate, the flow of diluent into the nozzle 19 starts before the flow of concentrate and continues after the flow of concentrate into the nozzle 19 stops. The deflector plate 73 is positioned under the port from the valve chamber 63d of the diluent flow control valve and directs at least part of the diluent flow into the nozzle 19 to flow over the ports from the valve chambers 63a, 63b, 63c of the concentrate flow control valves. This has a number of benefits and advantages.

Firstly, the flow of concentrate jets into a flow of the diluent as it passes over the concentrate port This results in enhanced mixing of the concentrate and diluent within the nozzle before the beverage is dispensed from the nozzle into the receptacle. This in turn leads to a more uniform mixing and improved appearance of the beverage in the receptacle.

Secondly, the flow of concentrate is prevented from impinging directly on internal surfaces of the nozzle. This inhibits adhesion of concentrate to the internal surface of the nozzle where it may remain after dispense of the beverage and contaminate subsequently dispensed beverages. The nozzle may be made of a material that further inhibits adhesion such as polyester.

Thirdly, the internal surfaces of the nozzle and concentrate ports are washed with diluent at the end of dispense when the concentrate flow control valve has closed. This removes all traces of concentrate from the internal surfaces of the nozzle and exposed surfaces of the concentrate ports within the nozzle. This in turn ensures that the entire volume of concentrate flowing into the nozzle when the concentrate flow control valve is open is dispensed into the receptacle to produce the desired quality of beverage. Moreover, the risk of contamination of subsequently dispensed beverages by carry over of concentrate from a previously dispensed beverage is significantly reduced. As a result of this self-cleaning function, nozzle hygiene is improved.

Fourthly, the concentrate valve pistons shut-off the flow of concentrate at the point of discharge into the nozzle itself so that no volume of concentrate remains downstream of the concentrate valve after dispense that can be sucked into and contaminate subsequently dispensed beverages.

Fifthly, the distribution of the diluent within the nozzle is enhanced by the deflector plate which assists in maintaining carbonation levels in the dispensed beverage when the diluent contains a dissolved gas such as carbon dioxide by helping to reduce break-out of the gas during dispense.

Sixthly, the distribution of the diluent within the mixing chamber formed by the nozzle due to the deflector plate leads to further improvements in the overall mixing and quality of the dispensed beverage. A further improvement may also be achieved by employing a tapered or cone-shaped mixing chamber that promotes mixing of the diluent and concentrate within the nozzle before dispense.

Seventhly, the flow of diluent within the nozzle is at least partially directed towards the internal surfaces of the nozzle by the deflector plate enabling a larger nozzle outlet to be used. As a result, admission of air into the nozzle at the end of dispense is improved leading to better 30 draining of the nozzle and reduced risk of beverage remaining in the nozzle and contaminating subsequently dispensed beverages. In addition, air may also be admitted to the nozzle to prevent a vacuum being created within the nozzle by the flow of diluent during dispense thereby helping to maintain carbonation levels where the diluent contains carbon dioxide or other gas by reducing break-out of the gas. Preventing formation of a vacuum may also help to maintain the correct mixing ratio of diluent and concentrate by preventing changes to the diluent and/or concentrate flows that could otherwise occur. The larger nozzle outlet may also make handling and use of the bar gun easier by increasing the angle at which the nozzle can be held when dispensing beverage into a receptacle without beverage collecting and remaining in the nozzle at the end of the dispense.

Other benefits and advantages of the above-described bar gun will be apparent to those skilled in the art. It will be understood that the invention is not limited to the embodiment above-described and various modifications and improvements can be made without departing from the various concepts described herein. For example, while the invention has been described with particular reference to a bar gun, it will be appreciated that any of the features could be employed in other forms of apparatus for dispensing post-mix beverages including post-mix beverage towers and dispensers. Moreover, any of the features may be employed separately or in combination with any other features and the invention extends to and includes all combinations and sub-combinations of one or more features described herein in any form of apparatus for dispensing post-mix beverages.

What is claimed is:

1-15. (canceled)

16. A bar gun for dispensing a beverage, said bar gun comprising a valve assembly for said bar gun including a diluent valve for said bar gun for controlling flow of a diluent and a concentrate valve for said bar gun for controlling flow of a concentrate, and a chamber for said bar gun in which diluent from said diluent valve and concentrate from said concentrate valve are mixed, said concentrate valve having an outlet through which concentrate can flow into said chamber, means provided in said chamber for directing diluent from said diluent valve towards said outlet, and actuator means on said bar gun for operating said diluent valve and said concentrate valve, said actuator means being configured for dispensing a mixture of diluent and concentrate wherein said diluent valve closes after said concentrate valve.

17. A bar gun according to claim 16 wherein, said actuator means is configured for dispensing a mixture of diluent and concentrate wherein said diluent valve opens before said concentrate valve.

18. A bar gun according to claim 16 wherein, said actuator means is configured for selectively dispensing either a mixture of diluent and concentrate or diluent without concentrate.

19. A bar gun according to claim 16 wherein, said actuator means comprises an actuator for said diluent valve and an actuator for said concentrate valve.

20. A bar gun according to claim 19 wherein operation of said diluent actuator dispenses diluent.

21. A bar gun according to claim 19 wherein operation of said concentrate actuator dispenses a mixture of concentrate and diluent.

22. A bar gun according to claim 16 wherein said diluent valve is biased to a closed condition and said actuator means is operable to move said diluent valve to an open condition.

23. A bar gun according to claim 16 wherein said concentrate valve is biased to a closed condition and said actuator means is operable to move said concentrate valve to an open condition.

24. A bar gun according to claim 16 wherein said outlet from said concentrate valve admits concentrate directly to said chamber when said outlet is open.

25. A bar gun according to claim 16 wherein said valve assembly includes a plurality of concentrate valves and said actuator means is configured such that diluent from said diluent valve may be mixed with concentrate from any selected one of said concentrate valves.

26. A bar gun according to claim 16 wherein said mixing chamber comprises a nozzle having an outlet for dispense of beverage.

27. Apparatus for dispensing a beverage, said apparatus comprising a valve assembly including a diluent valve for controlling flow of a diluent and a concentrate valve for controlling flow of a concentrate, and a chamber in which diluent from said diluent valve and concentrate from said concentrate valve are mixed, said concentrate valve having an outlet through which concentrate can flow into said chamber, means provided in said chamber for directing diluent from said diluent valve towards said outlet, an actuator for said diluent valve and an actuator for said concentrate valve, wherein operation of said diluent actuator dispenses diluent only and actuation of said concentrate actuator dispenses a mixture of diluent and concentrate wherein said diluent valve opens before and closes after said concentrate valve.

28. Apparatus for dispensing a beverage, said apparatus comprising a valve assembly including a diluent valve for controlling flow of a diluent and a concentrate valve for controlling flow of a concentrate, and a chamber in which diluent from said diluent valve and concentrate from said concentrate valve are mixed, said concentrate valve having an outlet opening directly into said chamber and a valve member movable to open and close said outlet such that no volume of concentrate remains downstream of said outlet when said concentrate valve is closed, means provided in said chamber for directing diluent from said diluent valve towards said outlet, and actuator means for operating said diluent valve and concentrate valve, said actuator means being configured for dispensing a mixture of diluent and concentrate wherein said diluent valve closes after said concentrate valve.

29. Apparatus according to claim 28 wherein said diluent valve opens before said concentrate valve.

30. A method of dispensing a beverage comprising providing a valve for admitting diluent to a mixing chamber at a first position, providing a valve for admitting concentrate to a mixing chamber at a second position, configuring said diluent and concentrate valves for selectively dispensing diluent only or a mixture of diluent and concentrate wherein, when dispensing said mixture, said diluent valve opens before and closes after said concentrate valve, and wherein diluent is directed towards said second position.
